(19) United States
(12) Patent Application Publication
(10) Pub. No.: US 2013/0186668 A1
(43) Pub. Date: Jul. 25, 2013

(54) Handheld Power Tool Having a Bearing Device

(71) Applicants: Christoph HAKENHOLT, Feldkirch (AT); Bernhard SANDER, Muenchen (DE)

(72) Inventors: Christoph HAKENHOLT, Feldkirch (AT); Bernhard SANDER, Muenchen (DE)

(73) Assignee: Hilti Aktiengesellschaft, Schaan (LI)

(21) Appl. No.: 13/558,055

(22) Filed: Jul. 25, 2012

(30) Foreign Application Priority Data
Jul. 26, 2011 (DE) 10 2011 079 819.6

(51) Int. Cl. B25F 5/00

(52) U.S. Cl. CPC B25F 5/00
USPC 173/213

(57) ABSTRACT

A handheld power tool is disclosed. The handheld power tool has a linear motor with a rotor. The tool also has a bearing device which has a bearing position for bearing support of the rotor. The bearing position has at least one guide strip which engages in a recess provided in the rotor.

This application claims the priority of German Patent Document No. DE 10 2011 079 819.6, filed Jul. 26, 2011, the disclosure of which is expressly incorporated by reference herein.

### BACKGROUND AND SUMMARY OF THE INVENTION

The present invention relates to a handheld power tool.

A handheld power tool having a linear motor is known from the unexamined German patent application DE 10 2007 000 488 A1. The linear motor of the previously known handheld power tool has a stator and a rotor. A rotor of the linear motor of the previously known handheld power tool is in the form of a fork and has two rods supported flatly in two air gaps of the stator. The stator in the previously known handheld power tool is leg-shaped with three legs, with the two air gaps situated between two of the three legs. The two air gaps form a bearing position for supporting the rotor in the form of a flat friction bearing in a mounting bracket.

It is also known from the prior art that a spade-shaped rotor on a linear motor of a handheld power tool may be supported by means of a bearing device in the form of a mounting bracket, so that it is longitudinally movable, with two outer sides of the rotor being held in two opposing grooves in the mounting bracket. Such a bearing device is shown schematically with a rotor in FIG. 1, the bearing principle of a mounting bracket there also being applicable for the handheld power tool disclosed in DE 10 2007 000 488 A1.

One problem with the handheld power tools known in the past is that a jamming effect may occur between the rotor and the bearing device when there is expansion of the rotor or the bearing position component of the linear motor during operation, e.g., caused by heat or some other cause.

It is fundamentally desirable to ensure reliable operation of a handheld power tool even in a broad temperature range, in particular to prevent jamming between the rotor and the bearing device.

The present invention will now be described, its object being to provide a handheld power tool with a linear motor which is less susceptible to expansion of a component of the linear motor than a handheld power tool known previously from the prior art.

According to the invention, a handheld power tool with a bearing device has a bearing position with at least one guide strip which engages in a recess provided in the rotor of a linear motor in the handheld power tool. While eliminating the mounting bracket, the concept according to the present invention achieves the result that an absolute thermal expansion of a characteristic length which is relevant for the bearing position is reduced by a multiple factor because of the great reduction in the characteristic length.

In concrete terms, the invention starts from the consideration that because of thermal expansion, jamming may occur between the rotor and the bearing device of a rotor due to thermal expansion. To prevent such jamming, some play is provided between the rotor and the bearing device. The dimensions of such play should depend on the maximum temperature difference, the material-specific thermal expansion coefficient and the respective characteristic length. The invention has recognized that this characteristic length extends over the entire width and/or height of the rotor in the case of the bearing device of a previously known handheld power tool.

In deviation from the bearing device according to the prior art, in which the entire width and/or the entire height of the rotor, which constitute(s) the characteristic length that is definitive for the thermal expansion, the bearing position of the bearing device in the present handheld power tool is formed by at least one guide strip, which engages in a recess provided in the rotor.

The invention has recognized that by bearing support of the rotor by the guide strip at the bearing position of the bearing device, which engages in the recess in the rotor, the definitive characteristic length can be reduced by a factor of 10 to 50, for example. The influence of the thermal expansion can thus be reduced by a similar factor. The definitive characteristic length is not the width or height of the rotor according to the concept of the invention but instead the characteristic length is the width of the guide strip, which is basically much narrower than the width/height of the rotor.

Because of this greatly reduced characteristic length, the required play may advantageously turn out to be small accordingly. The handheld power tool may be used in a large temperature range without impairing the safety of the power tool or causing excessive wear on the same due to high friction. Thus, with the handheld power tool according to the present invention, a stable guidance of the rotor in the bearing device which is comparatively free of frictional forces is possible.

Advantageous refinements of the invention are given in the dependent claims which provide details about advantageous possibilities for implementing the concept described above in conjunction with the object of the invention as well as with regard to additional advantages.

Within the framework of an especially preferred refinement of the design, the recess in the rotor is formed by at least one groove. This groove is preferably adapted to the dimensions of the guide strip and/or the guide strip and the groove are designed so that the guide strip engages a few millimeters deep into the rotor.

For bearing support of the rotor, the bearing position preferably has at least three guide strips, each of which preferably engages in a groove in the rotor which is provided for this purpose and two of which are aligned at an angle of more than 25° to one another. The three guide strips make it possible for the bearing position for the rotor to completely do without a groove-type bearing. In this case, the narrow width of the three guide strips alone forms the definitive characteristic length and not the width or height of the rotor, for example.

In a more extensive variant, the bearing position has at least four guide strips, which are arranged in pairs on opposite sides of the bearing device. The four guide strips preferably engage in four grooves provided for this purpose in the rotor.

The two guide strips of a pair are preferably aligned at an angle of approx. 90° to one another. In this variant the thermal expansion again has a reduced influence on the guide properties of the bearing device.

The bearing device is expediently designed for bearing support of the rotor between the opposing sides of the bearing position. It is preferable for one guide strip of one pair and one guide strip of the other pair to be arranged opposite one another on a rotor diagonal.

The bearing device with the at least one guide strip is suitable in particular for a spade-shaped rotor.

Within the context of another especially preferred refinement of the design, the bearing device is positioned in the handheld power tool for bearing support of the rotor in one axis of movement of a tool of the handheld power tool. The tool and the rotor as well as a mechanical transmission situated between them thus all lie in one axis of movement, so that the direction of movement of the rotor need not be reversed. This has a positive effect on the efficiency of the handheld power tool.

The handheld power tool is, for example, a handheld power tool having an electropneumatic (EP) hammer mechanism such as a jackhammer in which the tool of the handheld power tool is driven by the rotor. The handheld power tool may also be a keyhole saw or some other device in which an oscillating linear movement of the rotor is provided.

Exemplary embodiments of the invention will now be described on the basis of the drawings. These are not intended to represent the exemplary embodiments drawn to scale but instead the drawings are implemented in a schematic form and/or a slightly distorted form, where this serves the purpose of illustration. With regard to additions to the teachings directly discernible from the drawings, reference is made to the relevant prior art. One point to be taken into account here is that various modifications and changes may be made involving the shape and the details of an embodiment without deviating from the general idea of the invention. The features of the invention disclosed in the description, the drawings and the claims may be essential either individually or in any combination for the refinement of the invention. Furthermore, all combinations of at least two of the features disclosed in the description, the drawings and/or the claims fall within the scope of the invention. The general idea of the invention is not limited to the precise shape or detail of the preferred embodiment described and illustrated below nor is it limited to an object that would be restricted in comparison with the object claimed in the patent claims. With the dimension ranges given, values within the stated limits should also be disclosed as limit values and can be used and claimed as desired. For the sake of simplicity, the same reference numerals will be used below for identical or similar parts or for parts with identical or similar functions.

Additional advantages, features and details of the invention are derived from the following description of the preferred exemplary embodiments and on the basis of the drawings.

### BRIEF DESCRIPTION OF THE DRAWINGS

FIG. 1 illustrates a bearing device for a rotor according to the prior art;

FIG. 2 is a cross-section through an exemplary embodiment of a bearing device according to the present invention; and

FIG. 3 illustrates an exemplary embodiment of a handheld power tool according to the present invention.

### DETAILED DESCRIPTION OF THE DRAWINGS

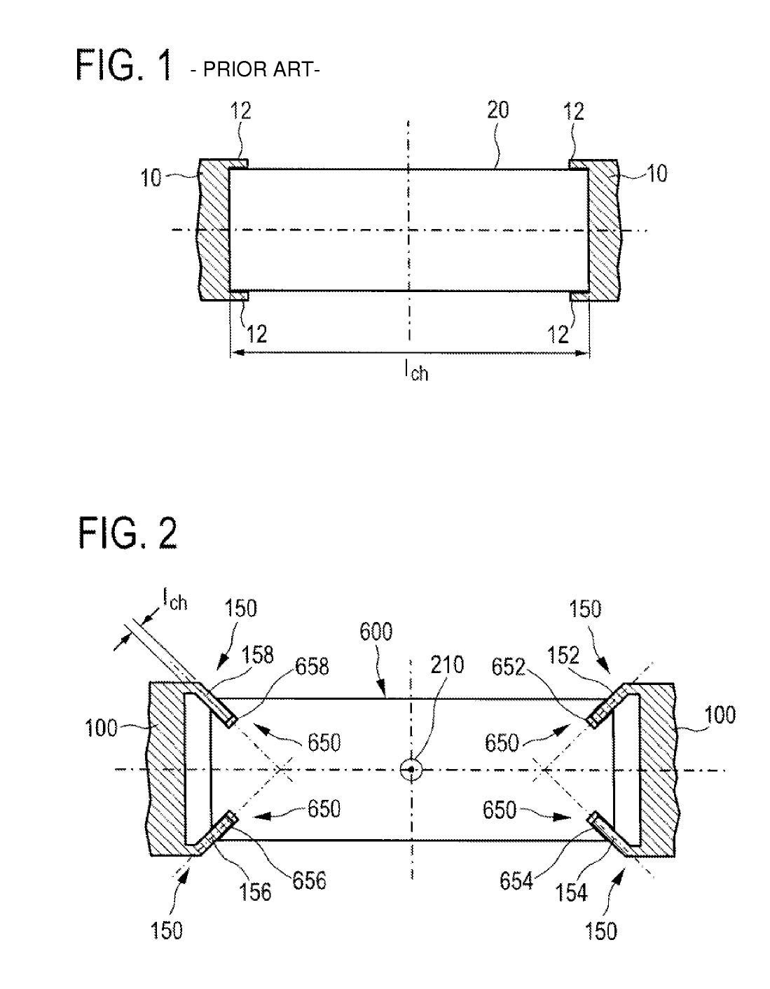

The disadvantages of a bearing device of a previously known handheld power tool can be illustrated on the basis of the schematic diagram in FIG. 1. The characteristic length l_{ch} extends there over the entire width and/or the total height, which is not identified further, of the rotor 20 because this (the rotor) is supported on the outsides by two grooves 12 in a mounting bracket of the previously known bearing device 10.

So far there have been two approaches for preventing jamming of the rotor:

A first approach is to design the play with generous dimensions to make it possible to rule out jamming. However, various material combinations may be used, and some components may heat up at different rates, so the required play can easily amount to 0.3 mm or more in this approach, depending on the characteristic length. However, such a large play is no longer acceptable, given the fact that the air gaps in the linear motors have become quite narrow in the meantime.

A second approach is to provide elastic elements which compensate for the thermal expansion and limit the play to almost zero. The elastic elements press on movable parts with a force which must be of a size such that multiple conditions are met, e.g., lateral yielding of the movable component should be reliably prevented, the frictional forces should be minimized, the material of the elastic elements should be largely free of wear, aging, etc. Maintaining these conditions is possible only with great effort on the one hand and on the other hand very high forces must be assumed especially in conjunction with magnets, therefore requiring an especially rigid embodiment of the elastic elements.

The concept of the invention, however, pursues a comparatively simple and nevertheless especially effective design approach.

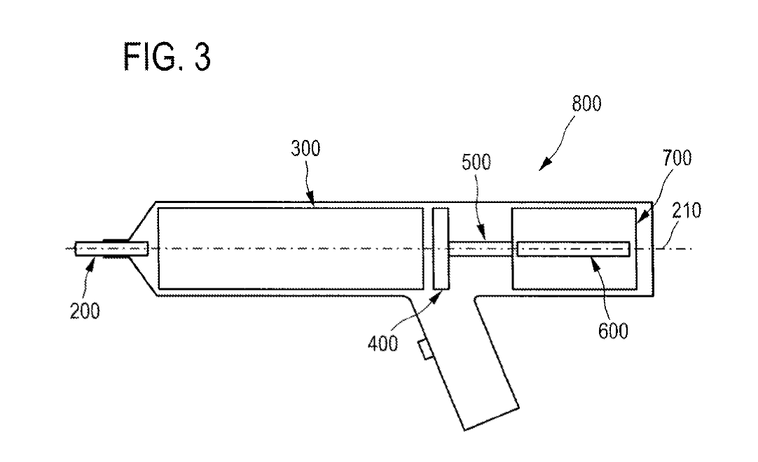

FIG. 2 shows the bearing device 100 in a cross-section according to the concept of the invention. The bearing device 100 for bearing support of a rotor 600 is part of a handheld power tool 800, which is illustrated schematically in FIG. 3, for example.

The handheld power tool 800 has a linear motor 700 with a spade-shaped rotor 600 and a bearing device 100 for bearing support of the rotor 600, which is shown in greater detail in FIG. 2. As also indicated schematically in FIG. 3, the rotor 600 lies in an axis 210 of movement of a tool 200 of the handheld power tool 800. In the present case, the rotor 600 is connected via a mechanical coupling 500 to a hammer piston, which drives the tool 200 via a mechanical transmission 300.

Furthermore, with reference to FIG. 2, the bearing device 100 has a bearing position 150 and is designed for mounting in the handheld power tool 800. The bearing position 150 has four guide strips 152, 154, 156, 158 arranged diagonally to one another. These guide strips are arranged in pairs on two opposing side of the bearing device 100 and each (152 and 154 and/or 156 and 158) is aligned at an angle of 90° to the others. Accordingly, the rotor 600 has a recess 650 in the form of four grooves 652, 654, 656 and 658, in which the four guide strips 152, 154, 156, 158 engage with comparatively little play—forming in effect a tongue-and-groove joint.

Fundamentally a tongue-and-groove joint of any other design than that shown in FIG. 2 may also be used to form a connection between the recess in the rotor and the engagement of the bearing device at a bearing position in a modification not shown here and following the principle of the present embodiment.

As explained above in conjunction with FIG. 1, the definitive characteristic length l_{ch} is obtained based on the width of a guide strip in this exemplary embodiment according to the concept of the invention. The characteristic length is thus reduced several times and thus the negative influence of an absolute thermal expansion is reduced to the same extent.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A handheld power tool, comprising:
a linear motor with a rotor, wherein the rotor includes a recess; and
a bearing device, wherein the bearing device has a bearing position, wherein the rotor is supported in the bearing position, and wherein the bearing position has a guide strip that is disposed in the recess of the rotor.

2. The handheld power tool according to claim 1, wherein the recess is a groove.

3. The handheld power tool according to claim 1, wherein the bearing position has at least three guide strips and wherein two of the at least three guide strips are aligned at an angle of greater than 25° to one another.

4. The handheld power tool according to claim 1, wherein the bearing position has four guide strips and wherein the four guide strips are arranged in pairs on opposite sides of the bearing device.

5. The handheld power tool according to claim 4, wherein two guide strips of one pair of the pairs are aligned at an angle of approximately 90° to one another.

6. The handheld power tool according to claim 4, wherein the rotor is supported in the bearing position between the opposite sides of the bearing device.

7. The handheld power tool according to claim 4, wherein a first guide strip of a first pair of the pairs and a second guide strip of a second pair of the pairs are arranged opposite one another on a rotor diagonal.

8. The handheld power tool according to claim 1, wherein the rotor has a spade shape.

9. The handheld power tool according to claim 1, wherein the rotor is supported in the bearing position along an axis of movement of a tool of the handheld power tool.

10. A handheld power tool, comprising:
a linear motor with a rotor, wherein the rotor includes a recess; and
a bearing device, wherein the bearing device has a guide strip that is disposed in the recess of the rotor.

11. The handheld power tool according to claim 10, wherein the recess is a groove.

12. The handheld power tool according to claim 10, wherein the bearing device has at least three guide strips and wherein two of the at least three guide strips are aligned at an angle of greater than 25° to one another.

13. The handheld power tool according to claim 10, wherein the bearing device has four guide strips and wherein the four guide strips are arranged in pairs on opposite sides of the bearing device.

14. The handheld power tool according to claim 13, wherein two guide strips of one pair of the pairs are aligned at an angle of approximately 90° to one another.

15. The handheld power tool according to claim 13, wherein the rotor is supported in the bearing device between the opposite sides of the bearing device.

16. The handheld power tool according to claim 13, wherein a first guide strip of a first pair of the pairs and a second guide strip of a second pair of the pairs are arranged diagonally opposite from one another.

17. The handheld power tool according to claim 10, wherein the rotor is spade-shaped.

18. The handheld power tool according to claim 1, wherein the rotor is supported in the bearing device along an axis of movement of a tool of the handheld power tool.
